(19) United States
(12) Patent Application Publication
(10) Pub. No.: US 2021/0173523 A1
(43) Pub. Date: Jun. 10, 2021

(54) CAPACITIVE TOUCH DEVICE AND OPERATING METHOD THEREOF

(71) Applicant: PixArt Imaging Inc., Hsin-Chu County (TW)

(72) Inventor: CHIA-YI LEE, Hsin-Chu County (TW)

(21) Appl. No.: 16/703,276

(22) Filed: Dec. 4, 2019

(51) Int. Cl. G06F 3/044; G06F 3/041; G06F 3/05

(52) U.S. Cl. CPC G06F 3/0446; G06F 3/05; G06F 3/041662; G06F 3/04182

(57) ABSTRACT

There is provided a capacitive touch device including a touch panel, a plurality of driving circuits, an analog front end and a digital back end. In a sleep mode, the plurality of driving circuits does not output driving signals to the touch panel, and the analog front end converts amplified and filtered noises outputted from the touch panel to digital signals. The digital back end identifies whether to leave the sleep mode according to the digital signals.

### BACKGROUND

### 1. Field of the Disclosure

This disclosure generally relates to an interactive input device and, more particularly, to a capacitive touch device and an operating method thereof capable of reducing the power consumption in the sleep mode.

### 2. Description of the Related Art

As the capacitive touch panel can provide a better user experience, it has been broadly applied to various electronic devices, e.g. applied to a display device so as to form a touch display device.

Generally speaking, if a capacitive touch panel is not operated by a user for a predetermined period of time, a sleep mode is entered to save power. In the sleep mode, the capacitive touch panel continuously to perform the scanning to confirm whether the sleep mode should be left. The power saving purpose can be achieved by reducing the scan frequency, scanning a part of electrodes or changing to a self-capacitance mode in the sleep mode. However, no matter which of the above mentioned method is adopted, the driving circuit will be used to input driving signals into the capacitive touch panel to generate detecting signals for the signal processing in the downstream circuit. Said driving circuit still consumes significant electricity.

Accordingly, the present disclosure provides a capacitive touch device and an operating method thereof that can further reduce the power consumption in a sleep mode or low power mode.

### SUMMARY

The present disclosure provides a capacitive touch device and an operating method thereof that identify whether a touch event occurs according to the noise magnitude (including background DC value of the capacitive touch device without driving signal) of the null scanning to accordingly leave a sleep mode (or referred to low power mode).

The present disclosure further provides a capacitive touch device and an operating method thereof that double check whether a touch event occurs according to a null frame obtained in a sleep mode and a driven frame obtained in a normal mode to improve the identification accuracy.

The present disclosure further provides a capacitive touch device and an operating method thereof that double check whether a touch event occurs according to the comparison result of comparing noise magnitudes in the null frame of different frequency bands with noise thresholds to improve the identification accuracy.

The present disclosure provides a capacitive touch device including a touch panel, a plurality of driving circuits, an analog front end and a processor. The plurality of driving circuits is configured to output driving signals to the touch panel in a normal mode, and not to output the driving signals to the touch panel in a sleep mode. The analog front end is configured to scan the touch panel in the sleep mode, and sample and output a null frame. The processor is configured to identify a touch event according to the null frame to accordingly leave the sleep mode and return to the normal mode.

The present disclosure further provides an operating method of a capacitive touch device including a plurality of driving circuits, a touch panel, an analog front end and a processor. The operating method includes the steps of: stopping outputting driving signals from the plurality of driving circuits to the touch panel; scanning, by the analog front end, the touch panel within an interval that the touch panel does not receive the driving signals to sample and output a null frame; and comparing, by the processor, noises of the null frame with a noise threshold to confirm whether to control the plurality of driving circuits to output the driving signals to the touch panel.

The present disclosure further provides an operating method of a capacitive touch device including a control chip and a touch panel. The operating method includes the steps of: controlling a plurality of switches of the control chip to bypass driving signals that are inputted into the touch panel; receiving, by the control chip, background noises outputted from the touch panel within an interval that the driving signals are bypassed, and amplifying the received background noises with a first gain value; and comparing, by the control chip, the amplified background noises with a noise threshold to control switching of the plurality of switches.

In the present disclosure, the normal mode is a mode in which the driving circuits output driving signals to the touch panel to identify a touch position; whereas, the sleep mode is a mode in which the driving circuits do not output the driving signals to the touch panel or the driving signals outputted by the driving circuits are bypassed and unable to enter the touch panel.

That is, an interval during which the driving circuits output driving signals is referred to a touching interval, and an interval during which the driving circuits stop outputting the driving signals is referred to a sleep interval or a frequency scanning interval. The frequency scanning interval is entered to select a suitable channel when the SNR value is not good enough, but the sleep interval is entered to save power when there is nobody operating the capacitive touch device.

In the present disclosure, compared with the normal mode, it is able to scan a part of electrodes (or regions) of the touch panel, extend the scanning period or reduce a number of times of scanning the touch panel in the sleep mode to further reduce the power consumption.

### BRIEF DESCRIPTION OF THE DRAWINGS

Other objects, advantages, and novel features of the present disclosure will become more apparent from the following detailed description when taken in conjunction with the accompanying drawings.

FIG. 1 is a schematic block diagram of a capacitive touch system according to one embodiment of the present disclosure.

FIG. 2 is a schematic block diagram of a capacitive touch system according to another embodiment of the present disclosure.

FIG. 3 is a schematic diagram of an analog front end of a capacitive touch system according to one embodiment of the present disclosure.

FIG. 4 is schematic diagram of a frequency selection method of a capacitive touch system according to one embodiment of the present disclosure.

FIG. 5 is a flow chart of a frequency selection method of a capacitive touch system according to one embodiment of the present disclosure.

FIG. 6 is a schematic block diagram of a capacitive touch device according to one embodiment of the present disclosure.

FIG. 7 is a flow chart of an operating method of a capacitive touch device according to one embodiment of the present disclosure.

FIG. 8 is an operational schematic diagram of a capacitive touch device according to one embodiment of the present disclosure.

FIG. 9 is a flow chart of an operating method of a capacitive touch device according to another embodiment of the present disclosure.

FIG. 10 is a flow chart of an operating method of a capacitive touch device according to an alternative embodiment of the present disclosure.

### DETAILED DESCRIPTION OF THE EMBODIMENT

It should be noted that, wherever possible, the same reference numbers will be used throughout the drawings to refer to the same or like parts.

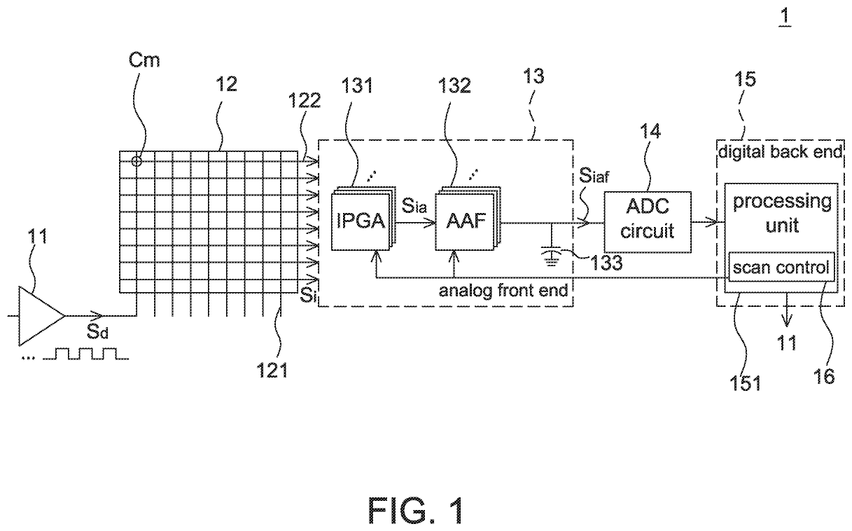

Referring to FIG. 1, it is a schematic block diagram of the capacitive touch system according to one embodiment of the present disclosure. The capacitive touch system 1 includes a plurality of driving units 11, a touch panel 12, an analog front end 13, an analog-to-digital conversion (ADC) circuit 14 and a digital back end 15. In some embodiments, the ADC circuit 14 may be included in the analog front end 13.

The analog front end 13 is configured to pre-process the analog signal outputted from the touch panel 12. Then, the pre-processed analog signal is converted to the digital signal by the ADC circuit 14 for the post-processing of the digital back end 15. Said pre-processing includes, for example, the amplification, downconversion, accumulation and filtering of the analog signal, but not limited thereto. Said post-processing includes, for example, identifying a touch position and/or a touch position variation (i.e. displacement) with respect to the touch panel 12 according to the digital signal, and identifying the noise level of the digital signal, but not limited thereto.

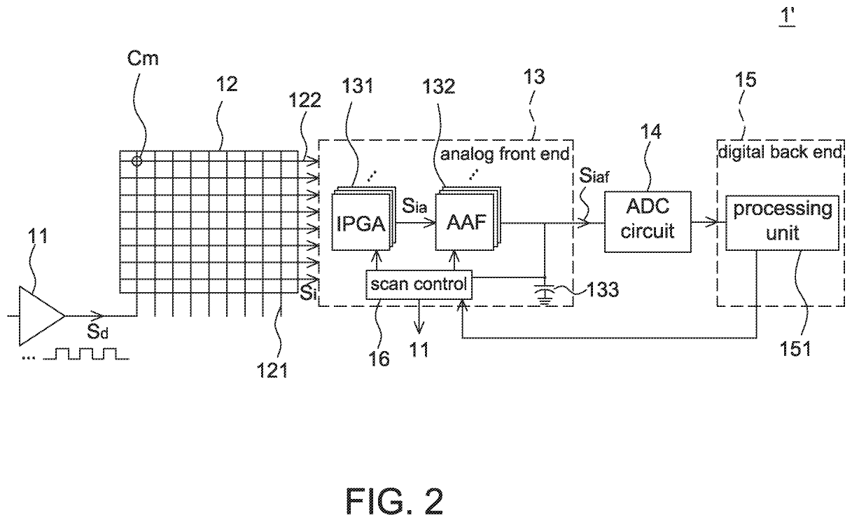

The touch panel 12 is, for example, a capacitive touch panel which includes a plurality of driving electrodes 121 and a plurality of sensing electrodes 122 configured to form inductive capacitance therebetween, wherein the inductive capacitance may be a self-capacitance and a mutual capacitance without particular limitations. For example, one driving electrode 121 may intersect with one sensing electrode 122 so as to form a sensing unit Cm, wherein FIGS. 1 to 2 only show one sensing unit Cm but for simplifying the drawings other sensing units Cm formed by other pairs of the driving electrodes 121 and the sensing electrodes 122 are not shown. The method of forming a plurality of driving electrodes and a plurality of sensing electrodes on a touch panel is well known and thus details thereof are not described herein.

When a driving signal Sd is inputted to the driving electrode 121, at least one detecting signal Si is induced on the sensing electrode 122 due to the inductive capacitance. When at least one finger or a conductor approaches the touch panel 12, the capacitance of the sensing units Cm nearby is changed to accordingly change the detecting signal 51. Accordingly, the processing unit 15 may detect at least one touch position according to the capacitance variation. The method of a capacitive touch system inducing at least one detecting signal Si corresponding to a driving signal Sd through the inductive capacitance is well known and thus details thereof are not described herein. The present disclosure is to provide a capacitive touch system and a frequency selection method thereof capable of shortening a frequency scanning interval and reducing the power consumption of the frequency scanning interval.

The driving units 11 are respectively coupled to the driving electrodes 121 and configured to output a driving signal Sd at one of a plurality of predetermined driving frequencies to the driving electrode 121 coupled thereto within a driving interval, and not to output the driving signal Sd to the driving electrode 121 coupled thereto within a frequency scanning interval. Referring to FIG. 4, it is a schematic diagram of a frequency selection method of a capacitive touch system according to one embodiment of the present disclosure. The capacitive touch system 1 is arranged with, for example, a plurality of predetermined driving frequencies such as 75 KHZ, 100 KHZ, 200 KHZ, 300 KHZ, 400 KHZ and 500 KHZ, but not limited thereto. The driving unit 11 output a driving signal Sd having, for example, periodic driving waveforms or non-periodic driving waveforms to the driving electrode 121 coupled thereto, wherein said driving waveforms are, for example, square waves, sinusoidal waves, triangular waves or trapezoid waves and so on without particular limitations.

Preferably, each of the driving electrodes 121 is coupled to one driving unit 11. For simplification, FIGS. 1 and 2 only show one driving unit 11, but it is not to limit the present disclosure. In some embodiments, the driving units 11 may be coupled to the driving electrodes 121 respectively through a change-over switch (not shown) so as to control the connection or breakup between the driving units 11 and the driving electrodes 121. Each of the driving units 11 also can be coupled to more than one driving electrodes 121, that is to say more than one driving electrodes 121 can be driven with one driving signal Sd at the same time.

When the driving signal Sd is inputted to the driving electrode 121, the associated sensing electrode 122 then outputs at least one detecting signal Si to the analog front end 13. In this embodiment, the analog front end 13 includes a plurality of amplification units 131 configured to perform the signal amplification and a plurality of filters 132 configured to perform the signal filtering. In one embodiment, the sensing electrodes 122 are coupled to the amplification units 131 respectively through a change-over switch (not shown) so as to control the output of the detecting signal Si through the change-over switches.

The amplification units 131 are, for example, integrated programmable gain amplifier (IPGA) and respectively coupled to the sensing electrodes 122. In one embodiment, each of the amplification units 131 is coupled to one of the sensing electrodes 122 and configured to amplify the detecting signal Si outputted from the sensing electrode 122 coupled thereto and output an amplified detecting signal Sia. In this embodiment, the amplification units 131 have the characteristic of the high-pass filter and have a high-pass cutoff frequency.

The filters 132 are, for example, anti-aliasing filters and respectively coupled to the amplification units 131. In one embodiment, each of the filters 132 is coupled to one of the amplification units 131 and configured to filter the amplified detecting signal Sia and output an amplified and filtered detecting signal Siaf. In this embodiment, the filters 132 have the characteristic of the low-pass filter and have a low-pass cutoff frequency.

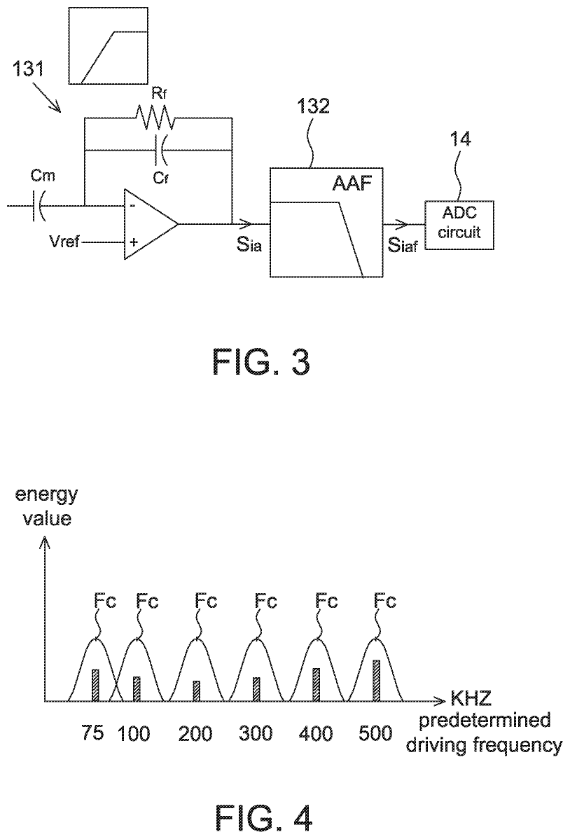

For example referring to FIG. 3, it is a schematic diagram of the amplification unit 131 and the filter 132 of the capacitive touch system 1 according to one embodiment of the present disclosure. The filter 132 outputs the amplified and filtered detecting signal Siaf to the ADC circuit 14 to be converted to the digital signal.

Referring to FIG. 1 again, the digital back end 15 includes a processing unit 151, which may be a digital signal processor (DSP), configured to perform the touch identification and determine whether to enter a frequency scanning mode, wherein the processing unit 15 may identify whether a conductor approaches the touch panel 12 according to the digital signal (e.g. obtained by digitizing the amplified and filtered detecting signal Siaf) detected within a predetermined detection interval (for example, but not limited to, 32 cycles of driving waveforms), and identify the signal-to-noise ratio (SNR) of the digital signal. For example in one embodiment, the driving unit 11 outputs the driving signal Sd at a current driving frequency to the touch panel 12, and the analog front end 13 further includes, for example, an accumulation capacitor 133 configured to accumulate charges of the amplified and filtered detecting signal Siaf within the predetermined detection interval. The ADC circuit 14 samples the voltage of the accumulation capacitor 133 and converts sampled values to the digital signal to be inputted to the processing unit 151. When the processing unit 151 identifies that an SNR value of the obtained digital signal is smaller than a threshold, the frequency scanning interval is entered, wherein the threshold may be determined according to the durable noise of the system without particular limitations.

In this embodiment, the processing unit 151 may further include a scan control unit 16 configured to control, in the frequency scanning interval, the high-pass cutoff frequency and the low-pass cutoff frequency so as to form an equivalent bandpass filter, and to adjust a center frequency of the equivalent bandpass filter to correspond to the predetermined driving frequencies. In addition, the scan control unit 16 is further configured to control, in the frequency scanning interval, the driving unit 11 to stop outputting the driving signal Sd to the touch panel 12 as well.

In one embodiment, the scan control unit 16 sequentially adjusts, in the frequency scanning interval, a center frequency Fc of the equivalent bandpass filter to be equal to each of the predetermined driving frequencies. For example in FIG. 4, the center frequency Fc of the equivalent bandpass filter is sequentially adjusted to substantially be equal to 75 KHZ, 100 KHZ, 200 KHZ, 300 KHZ, 400 KHZ and 500 KHZ, or vice versa. When the center frequency Fc is adjusted to each predetermined driving frequency, the scan control unit 16 detects the amplified and filtered detecting signal Siaf within a scan detection period (e.g. identical to or different from the predetermined detection interval of the driving interval, e.g. 32 cycles of driving waveforms). In the descriptions of the present disclosure, the frequency scanning interval is referred to an interval in which the touch panel 12 does not receive any driving signal Sd and the scan control unit 16 adjusts the cutoff frequencies, and the driving interval is referred to an interval in which the driving unit 11 inputs the driving signal Sd to the touch panel 12 and the processing unit 15 identifies the touch event according to the detected results.

In some embodiments, the scan control unit 16 identifies an amplified and filtered detecting signal having a smallest energy value among the amplified and filtered detecting signals Siaf associated with all the predetermined driving frequencies to accordingly determine a selected driving frequency. For example, the rectangular areas filled with slant lines in FIG. 4 indicate the detected energy values corresponding to each of the predetermined driving frequencies in the frequency scanning interval, and 200 KHZ is shown as the selected driving frequency herein. In some embodiments, said energy value may be an energy sum of the amplified and filtered detecting signals associated with at least a part of the sensing electrodes 122 outputted in the frequency scanning interval, e.g. adding amplified and filtered detecting signals Siaf associated with all the sensing electrodes 122 to be served as the energy value.

In another embodiment, after entering the frequency scanning interval, the scan control unit 16 may sequentially adjust the center frequency Fc of the equivalent bandpass filter to substantially be equal to rest predetermined driving frequencies among the predetermined driving frequencies other than the current driving frequency and two adjacent driving frequencies of the current driving frequency. As the frequency scanning interval is generally entered due to the high noise level in driving at the current driving frequency, the current driving frequency and its adjacent driving frequencies may be directly ignored in frequency scanning, e.g. two immediately adjacent driving frequencies thereof, but not limited thereto. In some embodiments, when the number of the predetermined driving frequencies is larger, a plurality of predetermined driving frequencies close to the current driving frequency may be ignored in the frequency scanning interval. Next, the scan control unit 16 may identify an amplified and filtered detecting signal having a smallest energy value among the amplified and filtered detecting signals Siaf associated with the rest predetermined driving frequencies so as to accordingly determine a selected driving frequency.

Referring to FIG. 2, it is a schematic block diagram of a capacitive touch system according to another embodiment of the present disclosure. The capacitive touch system 1′ also includes a plurality of driving units 11, a touch panel 12, an analog front end 13, an ADC circuit 14 and a digital back end 15. Similarly, the ADC circuit 14 may be included in the analog front end 13. The difference between this embodiment and FIG. 1 is that in this embodiment the scan control unit 16 is disposed in the analog front end 13 and configured to perform the frequency selection directly according to the energy value of the amplified and filtered detecting signal Siaf associated with the predetermined driving frequencies.

In one embodiment, the analog front end 13, for example, further includes an accumulation capacitor 133 configured to accumulate the amplified and filtered detecting signal Siaf within a predetermined detection interval. When the driving unit 11 outputs the driving signal Sd at a current driving frequency and the processing unit 151 identifies an SNR value of the obtained amplified and filtered detecting signal Siaf (e.g. obtained by sampling the accumulation capacitor 133 with the ADC circuit 14) is smaller than a threshold, a frequency scanning interval is entered. In the frequency scanning interval, the scan control unit 16 determines a selected driving frequency directly according to an amplified and filtered detecting signal having a smallest energy value among the amplified and filtered detecting signals Siaf associated with all the predetermined driving frequencies or the rest predetermined driving frequencies. It is appreciated that the method that the ADC circuit 14 samples the amplified and filtered detecting signal Siaf is not limited to sample the voltage of a capacitor as disclosed in the present disclosure.

In the above embodiments, as in the frequency scanning interval the driving unit 11 does not input any driving signal Sd to the touch panel 12, the amplified and filtered detecting signal Siaf outputted by the filters 132 only contain background noise, and thus the amplified and filtered detecting signal Siaf in the frequency scanning interval is sometimes referred to the amplified and filtered background signal for distinguishing.

In other words, according to FIGS. 1 and 2, the scan control unit 16 may be disposed in the analog front end 13 or in the digital back end 15 without particular limitations. The scan control unit 16 may identify a smallest energy sum according to the amplified and filtered detecting signal before being digitized (i.e. analog signal) or according to the amplified and filtered detecting signal after being digitized (i.e. digital signal) so as to accordingly determine a selected driving frequency.

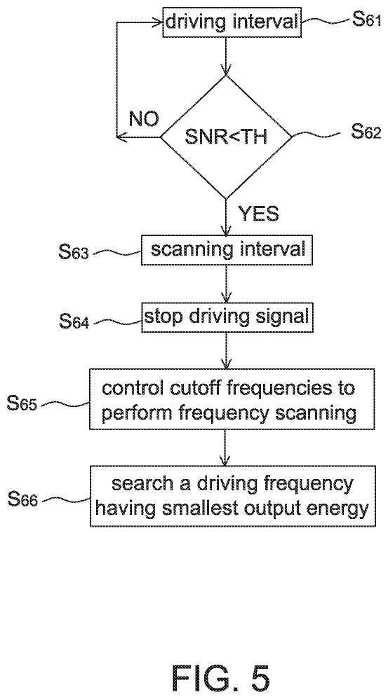

Referring to FIG. 5, it is a flow chart of a frequency selection method of a capacitive touch system according to one embodiment of the present disclosure, which includes the steps of: entering a driving interval (Step S₆₁); comparing an SNR value with a threshold (Step S₆₂); entering a frequency scanning interval when the SNR value is smaller than the threshold (Step S₆₃); deactivating driving signals (Step S₆₄); controlling cutoff frequencies to perform a frequency scanning (Step S₆₅); and searching a driving frequency having a lowest output energy value (Step S₆₆). The frequency selection method of this embodiment is adaptable to both the capacitive touch systems of FIGS. 1 and 2.

Referring to FIGS. 1 to 5, details of the frequency selection method of this embodiment are described hereinafter.

Step S₆₁: In a driving interval the driving unit 11 drives the touch panel 12 at a current driving frequency, and the driving signal Sd is induced as at least one detecting signal Si through the sensing unit Cm between the driving electrode 121 and the sensing electrode 122. The detecting signal Si sequentially passes through the amplification units 131 and the filters 132 to allow the filters 132 to respectively output an amplified and filtered detecting signal Siaf. The amplified and filtered detecting signal Siaf is, for example, accumulated in an accumulation capacitor 133 for a predetermined detection interval (e.g. 32 cycles of driving waveforms, but not limited thereto) and then converted to the digital signal by the ADC circuit 14. For simplification, the amplified and filtered detecting signal after being digitized is also referred as the amplified and filtered detecting signal herein.

Step S₆₂: The processing unit 151 identifies a touch event according to the amplified and filtered detecting signal Siaf and a noise level of the amplified and filtered detecting signal Siaf. When an SNR value of the amplified and filtered detecting signal Siaf exceeds a threshold, the driving interval (or touch detection mode) is maintained and the Step S₆₁ is returned; whereas when the SNR value is smaller than the threshold, a frequency scanning interval (or frequency scanning mode) is entered and the Step S₆₃ is entered.

Steps S₆₃-S₆₄: In the frequency scanning interval, the scan control unit 16 controls the driving unit 11 to stop driving the touch panel 12 or control the change-over switches between the driving units 11 and the driving electrodes 121 to break off. Accordingly, the touch panel 12 only outputs the background signal to the amplification units 131 such that the filters 132 output amplified and filtered background signals.

Step S₆₅: After the driving signal Sd is ceased, the scan control unit 16 controls a high-pass cutoff frequency of the amplification units 131 and a low-pass cutoff frequency of the filters 132 to form an equivalent bandpass filter, and adjusts a center frequency Fc of the equivalent bandpass filter to correspond to a plurality of predetermined driving frequencies so as to determine a selected driving frequency according to the amplified and filtered background signal obtained by adjusting the center frequency Fc of the equivalent bandpass filter, as shown in FIG. 4. In one embodiment, a band of the equivalent bandpass filter may be 50-100 KHZ, but not limited thereto.

Step S₆₆: In one embodiment, the scan control unit 16 reads the amplified and filtered background signal, which is an analog signal or a digital signal according to the disposed position of the scan control unit 16, outputted from the filters 132. For example in FIG. 1, the scan control unit 16 is in the digital back end 15 and thus the amplified and filtered background signal is the digital background signal converted by the ADC circuit 14. For example in FIG. 2, the scan control unit 16 is in the analog front end 13 and thus the amplified and filtered background signal is the analog background signal not being converted by the ADC circuit 14. In one embodiment, the scan control unit 16 identifies an amplified and filtered background signal having a smallest energy value among the amplified and filtered background signals associated with all the predetermined driving frequencies so as to accordingly determine a selected driving frequency. In another embodiment, the scan control unit 16 identifies an amplified and filtered background signal having a smallest energy value among the amplified and filtered background signals associated with the rest predetermined driving frequencies (i.e. other than the current driving frequency and its adjacent predetermined driving frequencies) so as to accordingly determine a selected driving frequency.

In one embodiment, the analog front end 13 and the digital back end 15 may form a readout circuit configured to couple to a touch panel 12 and read a plurality of detecting signals Si outputted by the touch panel 12. The readout circuit includes a plurality of amplification units 131, a plurality of filters 132 and a scan control unit 16. The amplification units 131 are coupled to the touch panel 12 and configured to amplify the detecting signals Si outputted by the touch panel 12, and have a high-pass cutoff frequency. The filters 132 are respectively coupled to the amplification units 131 and configured to output an amplified and filtered detecting signal Siaf, and have a low-pass cutoff frequency. The scan control unit 16 is configured to control the high-pass cutoff frequency of the amplification units 131 and the low-pass cutoff frequency of the filters 132 to form an equivalent bandpass filter, and adjust a center frequency Fc of the equivalent bandpass filter to correspond to at least a part of a plurality of predetermined driving frequencies of the touch panel 12, as shown in FIG. 4. As mentioned above, the scan control unit 16 may determine a selected driving frequency according to one amplified and filtered detecting signal having a smallest energy value among the amplified and filtered detecting signals Siaf associated with all or at least a part of the predetermined driving frequencies.

As mentioned above, the processing unit determines whether to enter a frequency scanning interval from a driving interval (or referred to normal mode) according to the SNR value. In addition, the processing unit further determines to enter a sleep mode to reduce the system power when identifying no touch event occurs for a predetermined time interval. In order to further reduce the system power within a sleep interval, a null scan is performed within the sleep interval in the present disclosure to confirm whether a touch event occurs and determine whether the sleep mode should be left. It should be mentioned that although the above driving interval and the sleep interval both can identify a touch event, they have different purposes. The driving interval is used to identify at least one touch position and/or a displacement to perform a corresponding control, but the sleep interval is used to identify whether a touch event occurs to return to the driving interval.

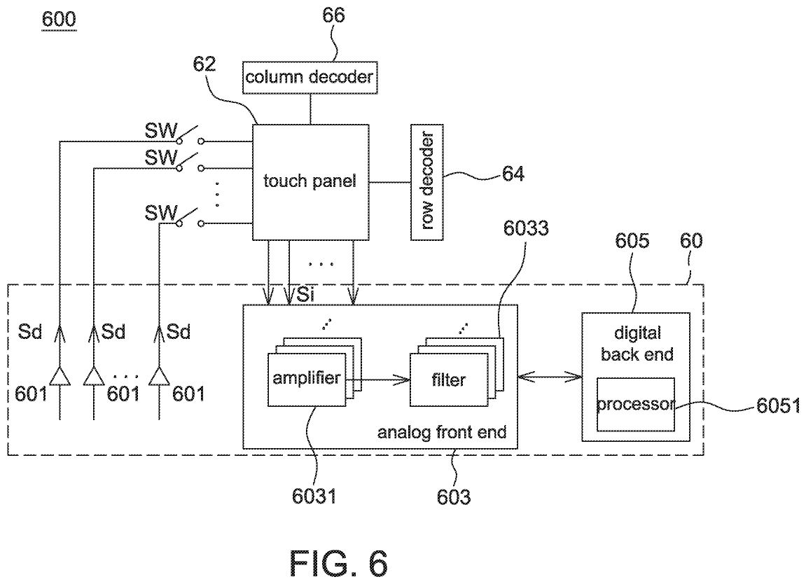

Please referring to FIG. 6, it is a schematic block diagram of a capacitive touch device 600 according to one embodiment of the present disclosure. The capacitive touch device 600 includes a control chip 60 and a touch panel 62 connected to each other via a bus line or multiple signal lines for the communication therebetween, wherein an example of the touch panel 62 is referred to the touch panel 12 mentioned in the previous embodiment and thus details thereof are not repeated herein. The control chip 60 is used to drive and scan the touch panel 62 to identify a current mode that the capacitive touch device 600 is being operated such as a normal mode, a frequency scanning mode or a sleep mode, wherein the normal mode and the frequency scanning mode have been illustrated above, and thus details thereof are not repeated herein. Details of the sleep mode (or referred to sleep interval) are illustrated hereinafter.

The control chip 60 is formed as a package structure that has multiple pins as input/output paths of signals. The control chip 60 includes a plurality of driving circuits 601, an analog front end 603 and a digital back end 605, wherein operations of the driving circuit 601, the analog front end 603 and the digital back end 605 are all considered to be executed by the control chip 60. In this embodiment, the plurality of driving circuits 601 output, in the normal mode, driving signals Sd to the touch panel 62 via the driving electrodes thereof to cause the the touch panel 62 to detect the capacitance variation, and the plurality of driving circuits 601 stops outputting, in the sleep mode, the driving signals Sd to the touch panel 62 via the driving electrodes thereof. In one aspect, the plurality of driving circuits 601 includes a signal generator and respectively coupled to the driving electrodes of the touch panel 62 via a plurality of switches SW. The plurality of switches SW are used to bypass the driving signals Sd from or conduct the driving signals Sd to the corresponding driving electrodes.

The analog front end 603 is connected to the sensing electrodes of the touch panel 62. In addition to scanning the touch panel 62 in the normal mode, the analog front end 603 is further used to scan the touch panel 62 in the sleep mode to sample and output a null frame, wherein the null frame herein is referred to a frame being generated by scanning and sampling the touch panel 62 when the touch panel 62 does not receive any driving signal. Said null frame contains the background noises or background signals mentioned above. In the present disclosure, said scanning is performed by, for example, control signals outputted from a row decoder 64 and a column decoder 66, and said sampling is performed, for example, by a correlated doubling sampling. Said scanning and sampling the touch panel 62 may be implemented by conventional techniques without particular limitations.

As mentioned above, the capacitive touch device 600 includes an ADC for converting the null frame into a digital frame. For simplification purposes, the digital frame is also called null frame herein.

The digital back end 605 includes a processor 6051, e.g., an application specific integrated circuit (ASIC), a digital signal processor (DSP) or a microcontroller unit (MCU), and is used to identify a touch event according to the digitized null frame to accordingly confirm whether to return to the normal mode from the sleep mode.

In another aspect, the analog front end 603 further includes an identifying circuit (not shown) used to identify the touch event according to the non-digitized null frame. In this case, the processor 6051 controls the capacitive touch device 600 to change an operation mode thereof after receiving a notification from the identifying circuit of the analog front end 603.

It is noticed that when a human body approaches the touch panel 62, the common mode noise is generated and contained in the background noises or background signals to increase a total noise level of the null frame. Accordingly, the present disclosure utilizes this common mode noise as a way to identify a touch event in the sleep mode. The identifying method includes:

1. Comparing a noise of every sensing unit (e.g., referring to FIGS. 1-2) of the null frame with a noise threshold to confirm the touch event. For example, the processor 6051 calculates a number of sensing units that have the noise exceeding the noise threshold. When the number exceeds a number threshold, the occurrence of a touch event is identified.

2. Comparing a summation of noises of at least one row or at least one column of the null frame with a noise threshold to confirm the touch event. For example, the processor 6051 calculates a number of sensing unit rows or sensing unit columns that have a summation of noises exceeding a noise threshold. When the number of sensing unit rows or sensing unit columns exceeds a number threshold, the occurrence of a touch event is identified. The summation of noises is added directly by a circuit in the touch panel 62, or implemented in the processor 6051 of the digital back end 605 without particular limitations.

3. Comparing a summation of all frame noises of the null frame with a noise threshold to confirm the touch event. Similarly, the summation of frame noises is added in the touch panel 62, or implemented in the processor 6051 of the digital back end 605 without particular limitations.

It is appreciated that the noise thresholds in the above three identifying methods are not identical.

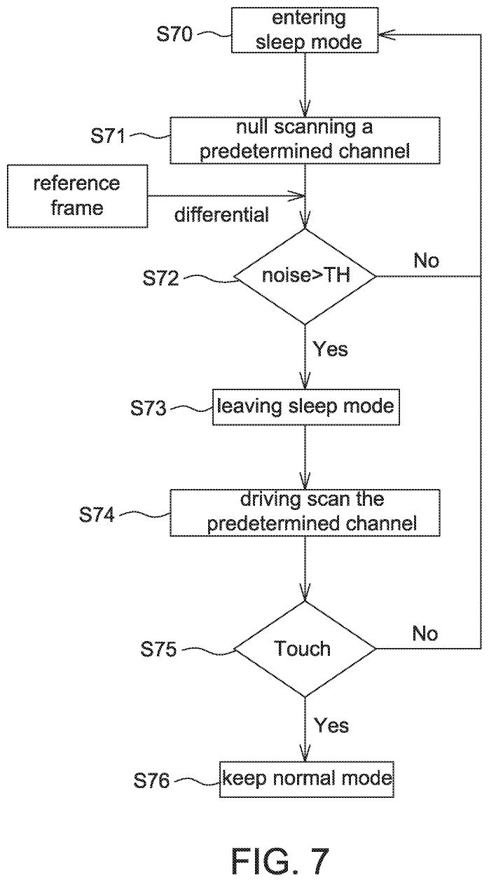

Please referring to FIG. 7, it is a flow chart of an operating method (or called awaking method) of a capacitive touch device 600 according to one embodiment of the present disclosure, including the steps of: entering a sleep mode (Step S70); null scanning a predetermined channel (Step S71); comparing a noise level with a noise threshold (Step S72) to determine whether to leave the sleep mode (Step S73).

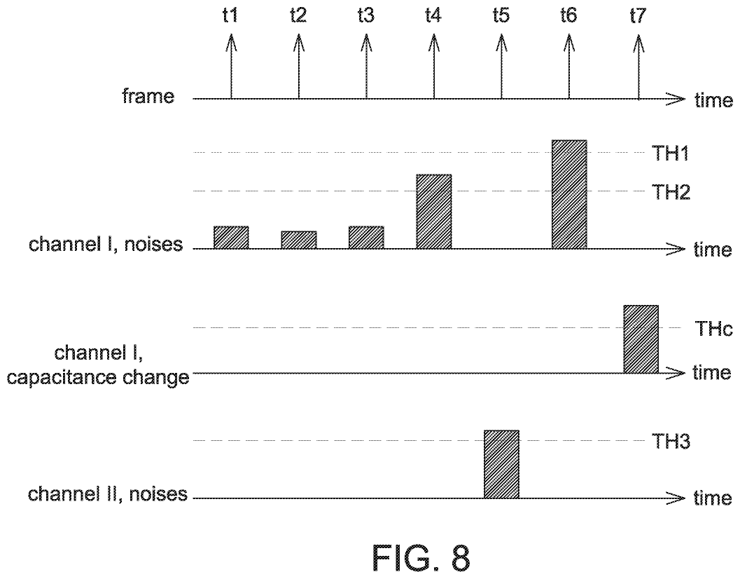

Referring to FIGS. 6 to 8, details of this embodiment is illustrated below. FIG. 8 shows that the touch panel 62 respectively generates one frame at times t1 to t7.

Step S70: When the processor 6051 does not detect any touch event for a predetermined time interval within the driving interval, a sleep mode is entered.

In this embodiment, after the sleep mode is entered, the touch panel 62 stops receiving driving signals Sd from the plurality of driving circuits 601. In one aspect, said stopping is implemented by controlling a plurality of switches SW of the control chip 60 to bypass the driving signals Sd that are inputted into the touch panel 62 via the driving electrodes thereof in the normal mode. In another aspect, the stopping is implemented by directly controlling the plurality of driving circuits 601 not to output any signal to the coupled driving electrodes. In this case, the capacitive touch device 600 may not include the plurality of switches SW.

Step S71: In an interval that the touch panel 62 does not receive the driving signals Sd (as mentioned above the driving signals Sd being bypassed or not outputted at all), the analog front end 603 scans the touch panel 62 to sample and output, using a predetermined scanning period, a null frame that contains background noises. For example, the analog front end 603 scans a predetermined channel (e.g., channel I or channel II in FIG. 8 each corresponding to one predetermined driving frequency mentioned above) of the touch panel 62 to sample and output a null frame, wherein the predetermined channel is one frequency selected from multiple driving frequencies for driving the touch panel 62, referring to FIG. 4.

As mentioned above, the analog front end 603 includes amplifiers 6031 and filters 6033 for respectively amplifying and filtering the null frame (or referred to background noises). For example, in the sleep mode, the amplifiers 6031 amplify the null frame with a first gain value. The amplifiers 6031 and the filters 6033 are respectively similar to the amplification units 131 and filters 132 mentioned above, and thus details thereof are not described herein.

Step S72: Next, the processor 6051 compares noises of the null frame with a noise threshold to confirm whether to control the plurality of driving circuits 601 to output driving signals Sd to the touch panel 62 and leave the sleep mode. For example, when the noises (e.g., the noise of at least one sensing unit as mentioned above) are larger than a noise threshold (e.g., different thresholds corresponding to different ways of calculating noises), the Step S73 is entered to leave the sleep mode; on the contrary, the sleep mode and the null scanning are maintained. The null scanning is referred to a scanning procedure while the touch panel 62 is not receiving any driving signal Sd.

In other words, by comparing noises of the null frame with the noise threshold, it is able to control ON/OFF of the plurality of switches SW or driving circuits 601. For example, when the amplified background noises (e.g., by a first gain value as mentioned above) is larger than the noise threshold (e.g., the frame at time t6 in FIG. 8 larger than a threshold TH1), the plurality of switches SW are controlled to conduct the driving signals Sd or the plurality of driving circuits 601 are controlled to output driving signals Sd to the touch panel 62. When the amplified background noises are smaller than the noise threshold (e.g., the frames at times t1 to t3 in FIG. 8 smaller than the threshold TH1), the Step S70 is returned and the touch panel 62 is null scanned continuously.

Step S73: After the sleep mode is left and the normal mode is entered, the capacitive touch device 600 identifies touch positions or displacement, and the operation thereof is described in the previous embodiment.

In addition, after entering the sleep mode, the capacitive touch device 600 preferably records and stores a reference frame corresponding to every predetermined channel (e.g., storing in a buffer) for eliminating background noises without human body approaching in a differential process. That is, the reference frame is a null frame without human body close to the touch panel 62. Then, after obtaining the null frame and before comparing the null frame with the noise threshold, the processor 6051 firstly calculates a difference between the null frame and the reference frame, and then compares the differential frame with the noise threshold to improve the identification accuracy. However, this step is optionally executed.

In one aspect, the differential process is performed between multiple pairs of pixels of a current null frame, and the calculated differential noise (i.e. obtained by subtracting the noise of one pixel from the noise of another pixel) is then compared with a differential noise threshold to determine whether a touch event is occurred or not. Preferably, the one pixel that is subtracted from another pixel is selected from those pixels having smaller magnitude of noises used as the reference background noise.

In an alternative aspect, the digital backend 605 calculates a differential noise between every pair of pixels at adjacent two rows or adjacent two columns, and then the calculated differential noise (i.e. obtained by subtracting the noise of one pixel from the noise of the adjacent pixel thereof) is then compared with a differential noise threshold to determine whether a touch event is occurred or not. For example, the digital backend 605 calculates the differential noise between first and second pixel rows (or columns), between third and fourth pixel rows (or columns), . . . , between the last pixel row (or column) and the pixel row (or column) previous to the last pixel row (or column).

In addition, in order to further improve the identification accuracy, FIG. 7 further includes the following steps after awaking (i.e., leaving the sleep mode) the device: performing a driving scan with the predetermined channel (Step S74); identifying a touch (Step S75) to determine whether to maintain a normal mode (Step S76) or return to the sleep mode. These steps are used to improve the identification accuracy in case the noises in the null frame larger than the noise threshold are not caused by the common mode noise induced by a human body. However, these steps are also optionally executed steps.

Step S74: After entering the normal mode, the touch panel 62 starts to receive the driving signals Sd, and the analog front end 603 scans the predetermined channel (e.g., same channel as the sleep mode) of the touch panel 62 to sample and output a driven frame, which is a frame outputted when the touch panel 62 is being driven by the driving signals Sd.

Step S75: The processor 6051 then double checks occurrence of the touch event (i.e. the touch event detected in the sleep mode) according to the driven frame. When the touch event is true, the normal mode is maintained (Step S76) and the corresponding control is performed; whereas when the touch event is not true, the capacitive touch device 600 is controlled to return to the sleep mode (returning to Step S70). For example, FIG. 8 schematically shows that at time t7 at least one sensing unit of the touch panel 62 has the capacitance variation larger than a capacitance threshold THc, and the occurrence of a touch event is confirmed. The method of identifying whether a touch panel 62 is touched in the driving interval has been illustrated above, and thus details thereof are not repeated herein. Besides, within an interval that the driving signals Sd are conducted, the control chip 60 amplifies the detecting signal Si outputted by the touch panel 62 with a second gain value smaller than the first gain value.

That is, after returning to the normal from the sleep mode, the processor 6051 preferably uses one or two driven frames to confirm whether the touch event is true or not so as to improve the accuracy of mode transformation. In one aspect, identical scans are performed in the normal mode and the sleep mode, and the difference is whether the driving signals Sd are inputted into the touch panel 62. In another aspect, the scanning period of the sleep mode is longer than the scanning period of the normal mode.

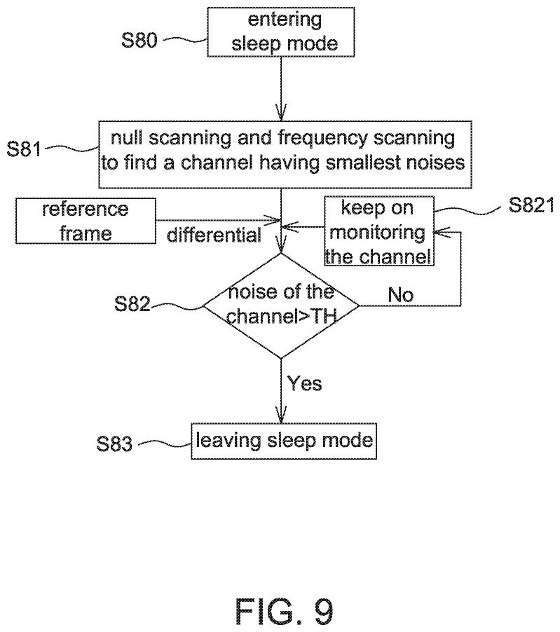

Please referring to FIG. 9, it is a flow chart of an operating method of a capacitive touch device 600 according to another embodiment of the present disclosure, including the steps of: entering a sleep mode (Step S80); performing null scanning and frequency scanning to find a channel having the smallest noises (Step S81): comparing noises of the channel with a noise threshold (Step S82) to leave a sleep mode (Step S82) or maintain the sleep mode (Step S821), wherein said frequency scanning is identical to the frequency scanning mode mentioned above. That is, in the embodiment of FIG. 5 a frequency scanning mode is entered when the SNR value is not good enough; and in this embodiment the frequency scanning mode is performed right after entering the sleep mode.

The Steps S80 and S83 in FIG. 9 are similar to the Steps S70 and S73 in FIG. 7, and thus details thereof are not repeated herein. The difference of this embodiment and FIG. 7 is that in FIG. 7 the control chip 60 confirms whether to awaken the capacitive touch device 600 according to the scanned result of a predetermined channel, whereas in FIG. 9, a frequency scanning is firstly performed to determine a channel having the smallest noises to replace the predetermined channel in FIG. 7, wherein the frequency scanning method has been illustrated in FIGS. 4 and 5.

In this embodiment, the frequency scanning is performed once or twice right after entering the sleep mode so as to find a channel having the smallest noises. As the sleep mode is an interval without user operation, performing the frequency selection procedure in the sleep mode does not influence the user experience.

After finding a null frame having the smallest noises by the frequency selection procedure, the processor 6051 uses the found channel having the smallest noises as the predetermined channel for scanning the touch panel 62, Step S81. As mentioned above, the analog front end 603 includes IPGA and AAF to form equivalent bandpass filter corresponding to the channel for scanning the touch panel 62.

In Step S82, the processor 6051 calculates a noise level of the selected channel having the smallest noises to be compared with the corresponding noise threshold (e.g., different channels having identical or different noise thresholds), wherein the method of calculating the noises has been illustrated above and thus details thereof are not repeated herein. When the noises of the channel having the smallest noises are larger than the corresponding noise threshold, the Step S83 is entered to leave the sleep mode; whereas when the noises of the channel having the smallest noises are smaller than the corresponding noise threshold, the noises of the channel having the smallest noises are continuously monitored in the sleep mode, Step S821, i.e. continuously performing the null scanning.

In the embodiment of FIG. 9, a difference between the null frame of the channel having the smallest noises and a reference frame is selected to be performed before the Step S82 to improve the identification accuracy, and details thereof are similar to FIG. 7 and thus are not repeated herein, wherein the reference frame may be different depending on the selected channel having the smallest noises. Similarly, after leaving the sleep mode in Step S83, the Steps S74 to S76 in FIG. 7 are further executed as FIG. 7 only the predetermined channel is changed to a channel having the smallest noises, and thus details thereof are not repeated herein.

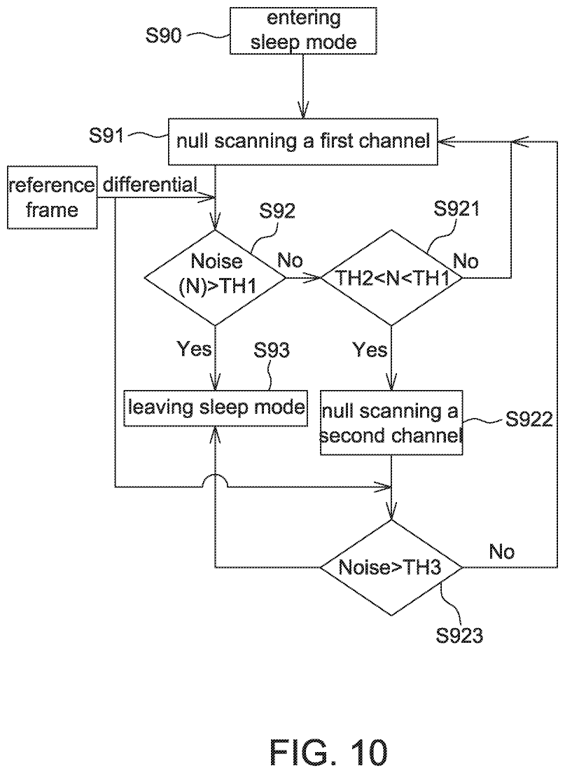

Referring to FIG. 10, it is a flow chart of an operating method of a capacitive touch device 600 according to an alternative embodiment of the present disclosure, including the steps of: entering a sleep mode (Step S90); null scanning a first channel (Step S91); comparing a noise level with at least one noise threshold (Step S92-S921) to determine whether to leave the sleep mode (Step S93); null scanning a second channel (Step S922); comparing a noise level with another noise threshold (Step S923) to determine whether to leave the sleep mode (Step S93), wherein the Steps S90 and S93 are similar to the Steps S70 and S73 in FIG. 7, and thus details thereof are not repeated herein.

The difference between this embodiment and FIGS. 7 and 9 is that in FIG. 10 a first channel (e.g., identical to or different from the predetermined channel in FIG. 7 or the smallest noise channel in FIG. 9) of the touch panel 62 is null scanned at first to obtain a null frame. When noises of the null frame is between two predetermined noise thresholds TH1 and TH2, a second channel is used to scan the touch panel 62 to obtain another null frame. Then, noises of said another null frame is compared with another noise threshold TH3 to confirm whether to leave the sleep mode again thereby increasing the identification accuracy. In this embodiment, the first channel (shown as channel I in FIG. 8) and the second channel (shown as channel II in FIG. 8) are, for example, respectively one of predetermined driving frequencies in FIG. 4.

In other words, in the embodiments of FIGS. 7 and 9, the processor 6051 compares amplified background noises obtained by scanning a single channel of the touch panel 62 with a noise threshold. However in FIG. 10, the processor 6051 compares amplified background noises obtained by scanning different channels of the touch panel 62 respectively with different noise thresholds to perform the double check.

For example, in Steps S92-S921, when the processor 6051 identifies that noises of the null frame associated with the first channel (e.g., a frame at time t6 in FIG. 8) are larger than a first noise threshold TH1, a touch event is confirmed and the Step S93 is entered, and the processor 6051 controls the plurality of driving circuits 601 to output driving signals Sd to the touch panel 62. When identifying that noises of the null frame associated with the first channel are smaller than the first noise threshold and larger than a second noise threshold (e.g., a frame at time t4 in FIG. 8 between thresholds TH1 and TH2), the processor 6051 controls the analog front end 603 to scan another predetermined channel (e.g., second channel) of the touch panel 62 to sample and output another null frame (e.g., a frame at time t5 associated with a second channel in FIG. 8), Step S922.

The processor 6051 then compares noises of the another null frame associated with the second channel with another noise threshold (Step S923), e.g., TH3 in FIG. 8, to confirm a touch event according to the another null frame associated with the second channel. For example, when the noises of the another null frame associated with the second channel are larger than TH3, the Step S93 is entered to leave the sleep mode; whereas when the noises of the another null frame associated with the second channel are smaller than TH3, the Step S91 is returned to continuously monitor a touch event in the sleep mode. In this embodiment, as the noise threshold TH3 is corresponding to a different channel, TH3 is preferably different from TH1 and TH2, but not limited thereto.

In this embodiment, the analog front end 603 is previously arranged to scan multiple channels (e.g., the multiple predetermined driving frequencies in FIG. 4) of the touch panel 62. Preferably, said another predetermined channel (e.g., the second channel) is a channel in the multiple channels farthest from the predetermined channel (e.g., the first channel), but the present disclosure is not limited thereto. Preferably, the second channel is not adjacent channels of the first channel.

In the embodiment of FIG. 10, a difference between the null frame associated with the first channel and a corresponding reference frame is selected to be performed before the Step S92 to improve the identification accuracy. Similarly, a difference between the null frame associated with the second channel and a corresponding reference frame is selected to be performed before the Step S923 to improve the identification accuracy. Details thereof are similar to FIG. 7 and thus are not repeated herein.

In FIG. 10, after leaving the sleep mode in Step S93, the Steps S74 to S76 in FIG. 7 are further executed as FIG. 7 only the predetermined channel is changed to a first channel (e.g., entering Step S93 from S92) or a second channel (e.g., entering Step S93 from S923), and thus details thereof are not repeated.

As mentioned above, in the conventional capacitive touch system, although the power consumption in a sleep mode can be reduced by extending the scanning period or reducing a number of sensing units being driven, a significant power is still consumed because the control chip or driving chip still outputs driving signals to a touch panel. Therefore, the present disclosure further provides a capacitive touch device (FIG. 6) and operating methods thereof (FIGS. 7-10) that sample and output a null frame by null scanning the touch panel in a sleep mode to identify whether a touch event occurs according to a noise level in the null frame and confirm whether to end the sleep mode. As the null scanning in the sleep mode is only used to confirm whether to leave the sleep mode without identifying a touch position, a summation of noises may be used for the identification.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A capacitive touch device, comprising:
a touch panel;
a plurality of driving circuits configured to output driving signals to the touch panel in a normal mode, and not to output the driving signals to the touch panel in a sleep mode;
an analog front end configured to scan the touch panel in the sleep mode, and sample and output a null frame; and
a processor configured to identify a touch event according to the null frame to accordingly leave the sleep mode and return to the normal mode.

2. The capacitive touch device as claimed in claim 1, wherein the processor is configured to
compare a noise of every sensing unit of the null frame with a noise threshold to confirm the touch event,
compare a summation of noises of at least one row or at least one column of the null frame with a noise threshold to confirm the touch event, or
compare a summation of all frame noises of the null frame with a noise threshold to confirm the touch event.

3. The capacitive touch device as claimed in claim 1, wherein the analog front end is configured to scan a predetermined channel of the touch panel to sample and output the null frame.

4. The capacitive touch device as claimed in claim 3, wherein after returning to the normal mode,
the analog front end is further configured to scan the predetermined channel of the touch panel to sample and output a driven frame, and
the processor is further configured to double check the touch event according to the driven frame, and control the capacitive touch device to maintain the sleep mode when the touch event is not true.

5. The capacitive touch device as claimed in claim 3, wherein the processor is further configured to
confirm occurrence of the touch event when identifying that noises of the null frame are larger than a first noise threshold,
control the analog front end to scan another predetermined channel of the touch panel to sample and output another null frame when identifying that the noises of the null frame are smaller than the first noise threshold and larger than a second noise threshold, and
confirm the touch event according to the another null frame.

6. The capacitive touch device as claimed in claim 5, wherein the analog front end is previously arranged to scan multiple channels of the touch panel, and the another predetermined channel is a channel among the multiple channels farthest from the predetermined channel.

7. The capacitive touch device as claimed in claim 5, wherein the analog front end comprises an integrated programmable gain amplifier and an anti-aliasing filter configured to form an equivalent bandpass filter corresponding to the scanned channel of the touch panel.

8. The capacitive touch device as claimed in claim 1, further comprising a plurality of switches respectively coupled to the plurality of driving circuits, and configured to conduct or bypass the driving signals.

9. The capacitive touch device as claimed in claim 1, wherein the processor is configured to find the null frame having smallest noises using a frequency selection procedure to determine a predetermined channel for null scanning the touch panel.

10. An operating method of a capacitive touch device, the capacitive touch device comprising a plurality of driving circuits, a touch panel, an analog front end and a processor, the operating method comprising:
stopping outputting driving signals from the plurality of driving circuits to the touch panel;
scanning, by the analog front end, the touch panel within an interval that the touch panel does not receive the driving signals to sample and output a null frame; and
comparing, by the processor, noises of the null frame with a noise threshold to confirm whether to control the plurality of driving circuits to output the driving signals to the touch panel.

11. The operating method as claimed in claim 10, wherein in the comparing, the processor compares
a noise of every sensing unit of the null frame with the noise threshold,
a summation of noises of at least one row or at least one column of the null frame with the noise threshold, or
a summation of all frame noises of the null frame with the noise threshold.

12. The operating method as claimed in claim 10, wherein in the scanning, the analog front end scans a predetermined channel of the touch panel to sample and output the null frame.

13. The operating method as claimed in claim 12, further comprising:
controlling, by the processor, the plurality of driving circuits to output the driving signals to the touch panel when the noises of the null frame are larger than a first noise threshold; and
controlling, by the processor, the analog front end to scan another predetermined channel of the touch panel to sample and output another null frame when the noises of the null frame are smaller than the first noise threshold and larger than a second noise threshold.

14. The operating method as claimed in claim 13, wherein the analog front end is previously arranged to scan multiple channels of the touch panel, and the another predetermined channel is a channel among the multiple channels farthest from the predetermined channel.

15. The operating method as claimed in claim 10, wherein before the comparing, the operating method further comprises:
calculating, by the processor, a difference between the null frame and a reference frame.

16. An operating method of a capacitive touch device, the capacitive touch device comprising a control chip and a touch panel, the operating method comprising:
controlling a plurality of switches of the control chip to bypass driving signals that are inputted into the touch panel;
receiving, by the control chip, background noises outputted from the touch panel within an interval that the driving signals are bypassed, and amplifying the received background noises with a first gain value; and
comparing, by the control chip, the amplified background noises with a noise threshold to control switching of the plurality of switches.

17. The operating method as claimed in claim 16, further comprising:
controlling the plurality of switches to conduct the driving signals to the touch panel when the amplified background noises are larger than the noise threshold; and
receiving, by the control chip, detecting signals outputted from the touch panel within an interval that the driving signals are conducted, and amplifying the received detecting signals with a second gain value smaller than the first gain value.

18. The operating method as claimed in claim 16, wherein the background noises include
a noise of every sensing unit of a frame outputted by the touch panel,
a summation of noises of at least one row or at least one column of the frame outputted by the touch panel, or
a summation of all frame noises of the frame outputted by the touch panel.

19. The operating method as claimed in claim 16, wherein the comparing comprises:
comparing the amplified background noises, which are obtained by scanning a single channel of the touch panel, with the noise threshold.

20. The operating method as claimed in claim 16, wherein the comparing comprises:
comparing the amplified background noises, which are obtained by scanning different channels of the touch panel, respectively with different noise thresholds.
